(19) United States
(12) Patent Application Publication
(10) Pub. No.: US 2003/0173755 A1
(43) Pub. Date: Sep. 18, 2003

(54) Bicycle drive mechanism

(76) Inventor: John Lachenmayer, Eagan, MN (US)

Correspondence Address: Scott A. Marks, 7350 Winnetka Heights Dr., Golden Valley, MN, 55427, US

(21) Appl. No.: 10/375,467

(22) Filed: Feb. 27, 2003

Related U.S. Application Data
(60) Provisional application No. 60/365,232, filed on Mar. 18, 2002.

(51) Int. Cl. B62M 1/04

(52) U.S. Cl. 280/252

(57) ABSTRACT

A mechanism for a pedaled vehicle such as a bicycle. The drive mechanism includes a first and second pedal connected to a first and second pedal guide. The first and second pedal guide are movably situated in parallel interior tracks. The tops and bottoms of both pedal guides are connected by a first and second chain. The first chain runs over a single first idler gear. The second chain runs over a first free-wheel, a bottom idler gear, and a second free-wheel. The first and second free-wheels convert the linear motion of each pedal and pedal guide into a unidirectional force that is applied to a drive shaft.

### CROSS-REFERENCE TO RELATED APPLICATION(S)

This application claims priority from U.S. Provisional Patent Application No. 60/365,232, filed Mar. 18, 2002, which is hereby incorporated by reference in its entirety.

### FIELD OF THE INVENTION

The present invention is directed to a pedal drive mechanism. More specifically, the present invention relates to a pedal drive mechanism incorporating reciprocal linear motion for powering bicycles, boats, and the like.

### BACKGROUND OF THE INVENTION

Conventional bicycles incorporate an axle located approximately midway between the front and rear tires. Affixed to the axle are shafts at the end of which are pedals that project outwardly from the bicycle. The pedals allow the user to utilize rotary leg and foot motion to generate propulsion. The axle, shaft, and pedal configuration require the rider's feet and legs to move in a generally circular motion to generate force. Such mechanisms are useful to power bicycles, tricycles, water trikes, pedal powered boats, and other types of vehicles. This motion is effective in creating the force needed to propel the vehicle forward, but does not do so with maximum efficiency.

The rotational motion used by conventional pedaled vehicles results in lost energy. The majority of the rotary pedal drive's power is developed during the downward portion of the rider's foot and leg motion. Since the downward motion is constrained to the arc of the circle, energy is not transferred from the rider to the rotary pedal drive system with maximum efficiency.

One type of drive mechanism that may be used as an alternative to the above conventional crank and sprocket type rotary drive mechanism, and which provides a more efficient utilization of the force exerted by the rider, is a linear drive mechanism. A linear motion drive can utilize an optimal range of the pedal motion for conversion to propulsion as compared to conventional rotary crank devices. Various types of linear drives are known in the art, but the complicated arrangements of such devices have limited their practical and commercial value.

### BRIEF SUMMARY OF THE INVENTION

The present invention is an improved drive mechanism that utilizes two pedals mounted to interior tracks. Each pedal is connected to a chain and sprocket system. The chain and sprocket system interacts with a dual free-wheel transmission to translate the linear pedaling motion of the rider into propulsion. The dual free-wheel transmission translates the reciprocating motion of the rider's legs and feet into a unidirectional rotational force on a drive shaft and a drive gear.

The present invention also includes drive mechanism for converting a rectilinear driving force to a rotary drive force for propulsion of a vehicle, comprising an interior track assembly including a first and second parallel path, a first and second guide affixed in the track assembly in a manner wherein the first and second guide are movable along the first and second paths, respectively, first and second pedals, the first and second pedals operably affixed to the first and second guide respectively, a first chain connecting the first and second guide, the first chain running from the first guide, through operable interaction with a first idler sprocket, and then to the second guide, a second sprocket operably attached to the interior track assembly, a first free-wheel and a second free-wheel mounted to a drive shaft at a distal end of the interior track assembly wherein a second chain connects the first guide to the second guide through operable engagement with the first free-wheel, the second idler sprocket, and the second free-wheel.

The present invention further includes pedaled propulsion apparatus for propelling a vehicle, comprising a track assembly with a first and second interior track operably mounted to the vehicle, a first and second pedal guide movably situated in the first and second interior tracks, respectively, the first and second pedal guide each attached to a first and second pedal arm and a first and second pedal and a first chain and a second chain, the first chain attached to a first end of the first pedal guide, operably engaging a first idler sprocket rotationally affixed to the track assembly and thereafter affixed to the second pedal guide, the second chain sequentially engaging a second end of the first pedal guide, a first free-wheel, a second idler sprocket, a second free-wheel, and a second end of the second pedal guide, wherein the second idler sprocket is rotationally affixed to the track assembly and the first and second free-wheels are drivingly mounted to a drive shaft wherein when one free-wheel rotates the drive shaft in an operable direction to provide propulsion the other free-wheel rotates freely.

The present invention also includes a drive mechanism for converting a rectilinear driving force to a rotary drive force for propulsion of a vehicle, comprising a housing including an interior track assembly, the interior track assembly including a first and second path, a first and second pedal fixedly attached to a first and second pedal guide, respectively, the first and second pedal guide in movable engagement with the first and second path, a first chain connecting the first and second guide through engagement with a first idler sprocket, a first free-wheel and a second free-wheel fixedly connected at a position below the first and second path and operably attached to a drive shaft, a second idler sprocket fixedly connected above the first and second free-wheels, and a second chain connected to the first and second pedal guide through engagement with the first free-wheel, the second idler sprocket, and the second free-wheel.

### BRIEF DESCRIPTION OF THE DRAWINGS

FIG. 1 shows an elevational view of the right side of a bicycle with a drive mechanism according to the present invention.

FIG. 2 shows a perspective view of the front side of the drive mechanism of FIG. 1 without the interior components and with the flashing removed.

FIG. 3 shows a perspective view of the front side of the interior components of the drive mechanism of FIG. 2.

FIG. 4 shows a perspective view of the front side of the drive mechanism of FIG. 2 with the interior components with the flashing removed.

FIG. 5 shows a perspective view of the front side of the drive mechanism of FIG. 2.

FIG. 6 is a perspective view of the rear side of the first pedal guide with the pedal arm, bearings and bearing rings of FIG. 2.

FIG. 7 is a plan view of the cross section of the channel of the drive mechanism.

FIG. 8 is a perspective view of the first pedal guide.

FIG. 9A is a plan view of the front side of the bearing ring of FIG. 6.

FIG. 9B is a plan view of the side of the bearing ring of FIG. 6.

FIG. 10 is a perspective view of the second idler sprocket bracket.

FIG. 11 is a perspective view of the front side of the transmission bracket.

FIG. 12A is an elevational view of the front side of the first free-wheel collar of the drive mechanism of the present invention.

FIG. 12B is a plan view of the first free-wheel collar of the drive mechanism of the present invention.

FIG. 13A is an elevational view of the first idler sprocket of the drive mechanism of the present invention.

FIG. 13B is a plan view of the front side of the first idler sprocket.

FIG. 14 is a plan view of the drive shaft.

### DETAILED DESCRIPTION

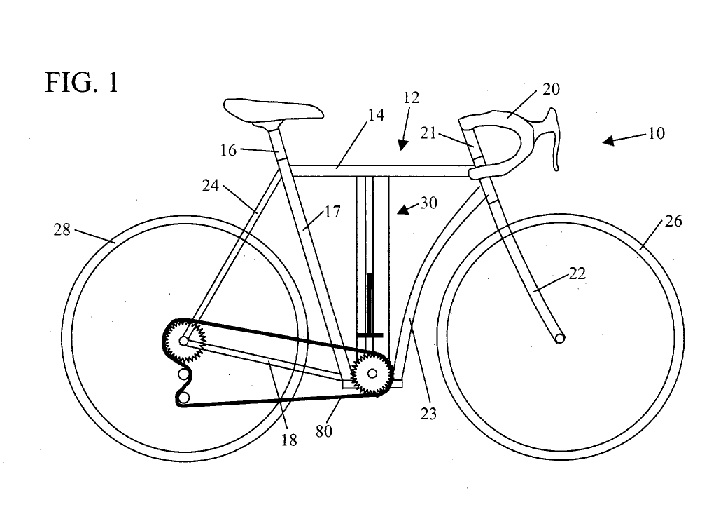

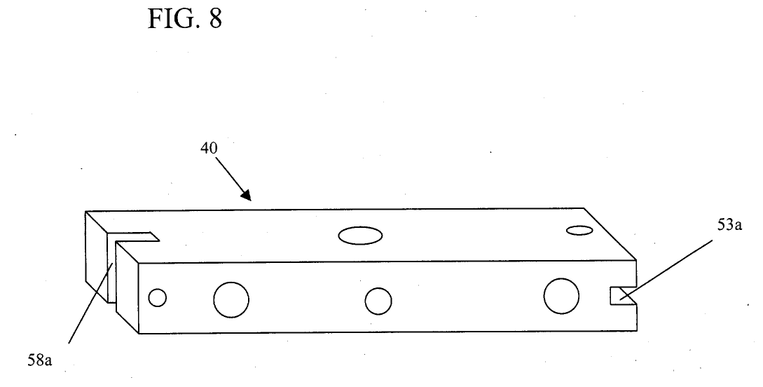

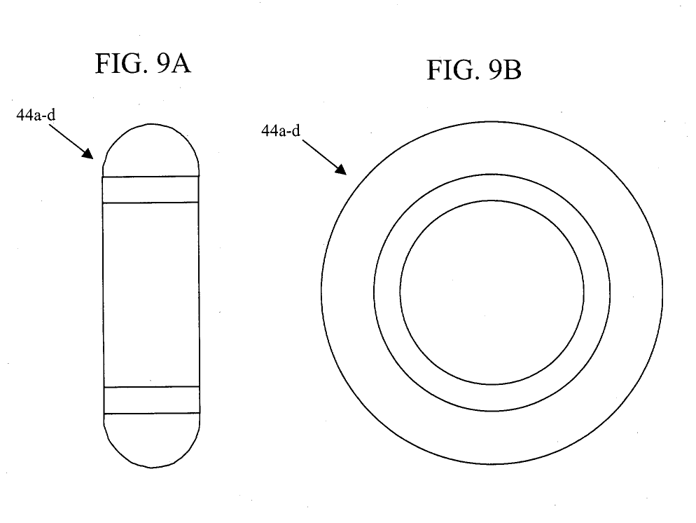

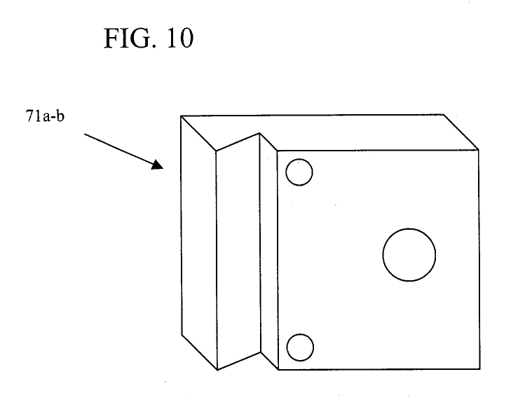

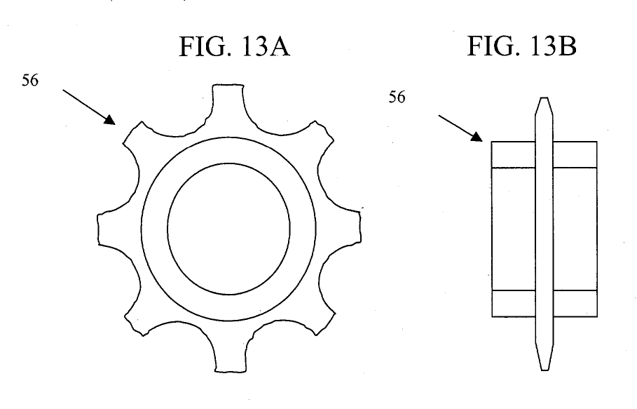

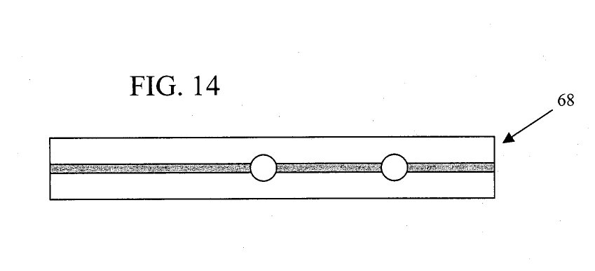

With reference to FIGS. 1-14, a linear motion drive mechanism according to one embodiment of the present invention will be herein described. The present embodiment is described in terms of a drive mechanism 30 for a bicycle 10. A drive mechanism that comports with the present invention may also be utilized with other pedal driven vehicles, for example, but not limited to, water trikes, recumbent bicycles, human powered catamarans, and the like.

The Drive Mechanism

With reference to FIG. 1, a first side of bicycle 10 is illustrated. The bicycle 10 has a frame 12, an upper tube 14, a seat stay 16, a seat tube 17, a rear lower fork 18, a handlebar 20, a steering header 21, a front fork 22, a lower tube 23, a rear upper fork 24, a front wheel 26, and a rear wheel 28. The above portions of the bicycle 10 may be placed together in a standard configuration. Portions of the frame 12 of the present embodiment of bicycle 10 may be adjusted in length and configuration in order to accommodate the present invention, but the present invention description will assume a standard size and configuration bicycle 10.

The bicycle 10 includes a drive mechanism of the present invention as drive mechanism 30. The drive mechanism 30 is mounted at a position between the seat tube 17 and the lower tube 23. The drive mechanism 30 is mounted to the bicycle 10 by welding, bolting, or by other means known to those in the art.

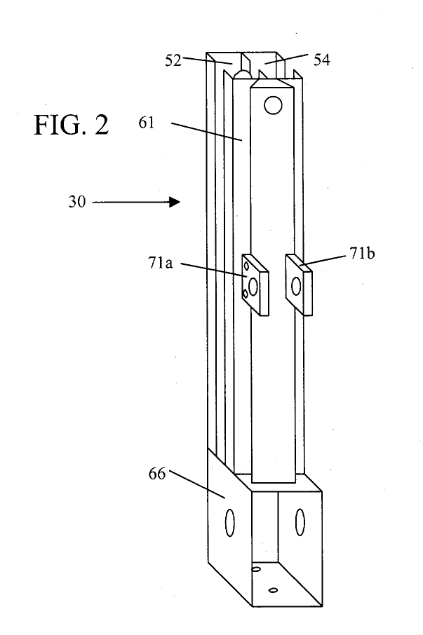

As illustrated in FIGS. 2, 3 and 4, the drive mechanism 30 includes first foot pedal 32 mounted to a first pedal arm 34 and second foot pedal 36 mounted to a second pedal arm 38. The first pedal arm 34 is fixedly attached to a first pedal guide 40. The second pedal arm 38 is fixedly attached to a second pedal guide 42. The second foot pedal 36, the second pedal arm 38, and the second pedal guide 42 are substantially the same as the corresponding first foot pedal 32, first pedal arm 34, and first pedal guide 40. Therefore, only the first foot pedal guide 40 will be described.

The first pedal guide 40 is movably mounted along a path of a first interior track 52 contained in a housing 61. The pedal guide 40 is movably connected with the track 52 of housing 61 in such a manner that the pedal guide 40 is free to move up and down inside the track 52.

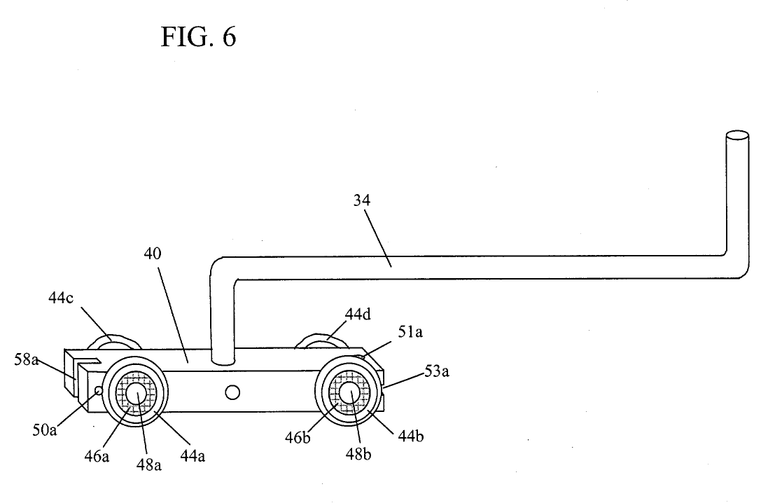

As illustrated in FIGS. 6 and 8-10 and 14 the first pedal guide 40 includes a bearing rings 44a-d, bearings 46a-d (46c-d not visible in FIG. 6) and bearing axles 48a-b. The bearing rings are fixedly attached to the outside of bearings 46a-d. The bearings 46a-d are mounted onto bearing axles 48a-b. The bearing axles are rotationally attached to first pedal guide. The bearing rings 44a-d may be made of metal or a Teflon™ type material. The bearings 46a-d and bearing rings 44a-d allow the pedal guide 40 to maintain a uniform low friction movement along the track 52. A Teflon™ material may provide a substantially quiet rolling motion as compared to a metal ring.

The second pedal guide 42 moves in a second track 54 of housing 61 in substantially the same manner. The first interior track 52 and the second interior track 54 run in vertical parallel paths inside the housing 61 of the drive mechanism 30.

The drive mechanism 30 of the present invention further includes a first chain 55 and a first idler sprocket 56. A first end of the first chain 55 is fixedly connected to the first pedal guide 40 at grooves 58a by a first chain pin 50a. The first chain 55 extends from the first pedal guide 40 to the first idler sprocket 56. The first idler sprocket 56 is mounted on first idler sprocket axle 57 (not shown) so that the first idler sprocket 56 rotates perpendicular to the direction of travel of the bicycle 30. After the first chain 54 engages the first idler sprocket 56, the first chain 55 connects to the second pedal guide 42 at grooves 58b by a second chain pin (not shown). The grooves 58a and 58b may be machine-milled in the guides 40, 42 and the chain 55 may be secured by the chain pins or in any other manner known in the art. The action of the first chain 55 in the drive mechanism 30 is further described below.

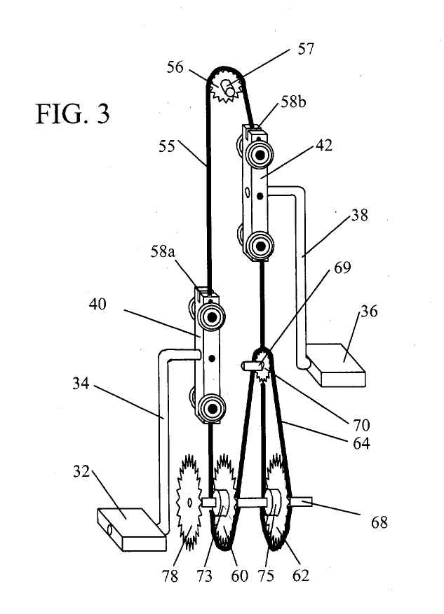

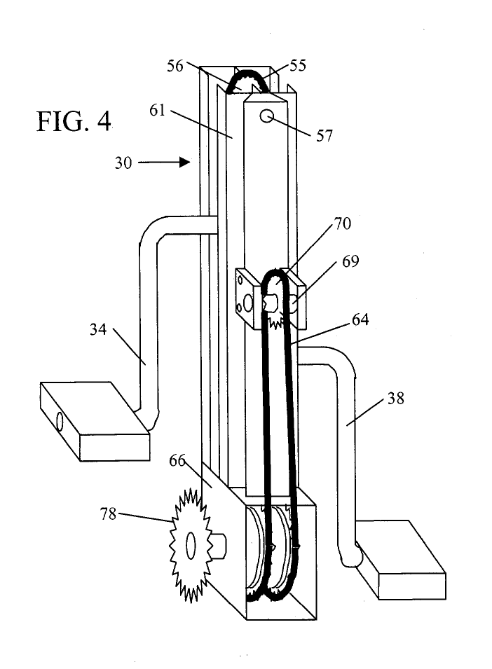

The drive mechanism 30 further includes a first free-wheel 60, a second free-wheel 62, a second chain 64, a transmission bracket 66, a drive shaft 68, a second idler sprocket 70, second idler sprocket brackets 71a-b, second idler sprocket axle 69 (not shown) and drive gear 78. Second idler sprocket 70 is similar in size and shape to first idler sprocket 56. The transmission bracket 66 is attached to the base of housing 61 of the drive mechanism 30. As illustrated in FIGS. 3 and 4 the drive shaft 68 is rotatably affixed inside of the transmission bracket 66. Drive gear 78 is on a first end of the drive shaft 68. The second idler sprocket 70 is mounted on second idler sprocket axle 69. Second idler sprocket axle 69 is rotationally mounted to the second idler sprocket brackets 71a-b which are fixedly attached to second idler sprocket bracket mounting base 63 on the exterior of housing 61. The first free-wheel 60 and the second free-wheel 62 are operably affixed to the drive shaft 68 in a side-by-side configuration inside the transmission bracket 66. The first free-wheel 60 and the second free-wheel 62 are rotatably mounted at a position below the first pedal guide 40 and the second pedal guide 42, respectively. The interaction of the first and second free-wheels 60, 62 are further described below.

The free-wheels 60, 62 may be standard type free-wheels known in the bicycle arts. Such free-wheels 60, 62 have a ring of teeth around the outside that operably interact with a chain. The ring of teeth is fixedly connected to a first inner loop (not shown) and rotates in coordination with the same. The first inner loop engages a second inner loop (not shown). When the first inner loop moves in a first direction the second inner loop is driven in a first direction. When the first inner loop is driven in a second direction, the second inner loop is not drive, instead acting as a “free” wheel. Such standard systems are known in the art and will not be further described herein. The free-wheel utilized herein may also be known as a sprag clutch, a one way clutch, or by other names.

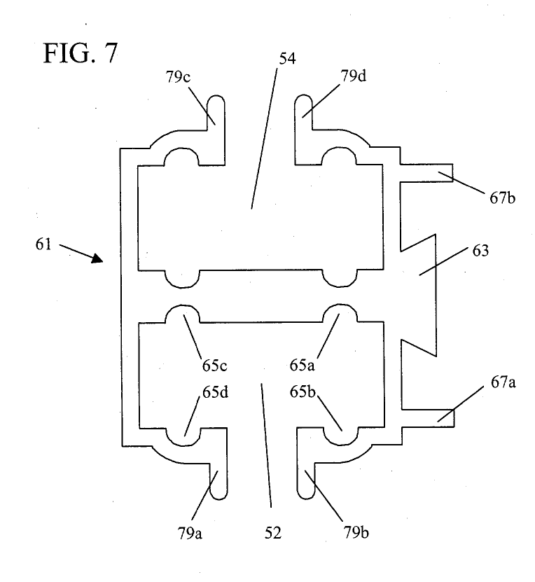

The cross section of the housing 61 is shown in FIG. 7. Housing 61 includes first interior track 52 and a second interior track 54. Housing 61 also includes a second idler sprocket bracket mounting base 63 and bearing ring wells 65a-d. Bearing ring wells 65a-d provide a groove for the bearing rings on first pedal guide 40 to ride in. Housing 61 also includes flashing mounting bases 67a-b. Flashing mounting bases 67a-b provide a means to fixedly attach flashing 59 to mechanism 30. Housing 61 also includes ribs 79a-d. Ribs 79a-d may provide increased strength to tracks 52 and 54. Housing 61 may be extruded from aluminum or fabricated from other metals or manmade materials. Housing 61. may be extruded, machined or formed by other processes known to art.

As is also illustrated, a first end of the second chain 64 is fixedly connected to the first pedal guide 40 at grooves 53a by a second chain pin 51a and extends through the first chain hole 72 of the transmission bracket 66 to engage the first free-wheel gear 60. The second chain 64 then extends to engage the second idler sprocket 70. The second chain 64 interacts with the second idler sprocket 70 and thereafter to the second free-wheel 62. After engaging the second free-wheel 62, a second end of chain 64 is fixedly connected to the second pedal guide 42 in a manner similar to the connection of the first chain to the first pedal guide.

The second idler sprocket brackets 71a-b in the present invention are located at a central position relative to the first and second free-wheels 60, 62. The second idler sprocket brackets 71a-b are fixedly attached to the second idler sprocket bracket base 63. The second idler sprocket's 70 position can be adjusted by utilizing the second idler sprocket brackets 71a-b. Adjusting the position of the second idler sprocket 70 allows for the amount of tension, and therefore the slack of the second chain 64, to be adjusted as required. Since the first chain 55, the second chain 64, and the pedal guides 40, 42 create a continuous loop, the maintenance of tension balance between the first chain 55 and the second chain 64 provides for a smoothly operating drive mechanism 30 that retains each pedal guide 40, 42 in the proper relative position and provides for a highly efficient transferal of rider input energy into propulsion.

As may be appreciated, the second chain 64 moves laterally between the first free-wheel 60, the second idler sprocket 70, and the second free-wheel 62. The second chain 64 must be able to connect between the free-wheels 60, 62, the pedal guides 40, 42, and the second idler sprocket 70 and still travel smoothly over the same.

As may be further appreciated, the second chain 64 requires some ability to deflect transversely along its length. A standard bike chain may be utilized that has such characteristics. In alternative embodiments, the chain may be replaced by a cable, a rope, or some other device useful for transferring force. In such alternative embodiments, the first various toothed sprockets could also be replaced.

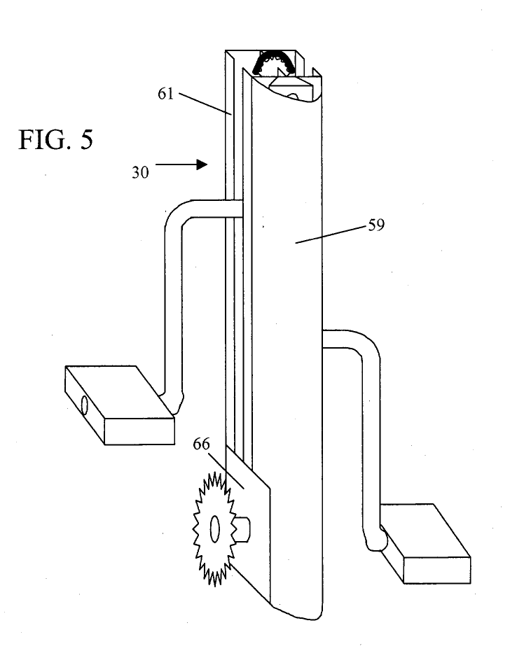

As illustrated in FIG. 5, a flashing 59 is mounted on the front of the drive mechanism 30 that substantially covers the free-wheel gears 60, 62, the second chain 64, and the second idler sprocket 70. Such a flashing 59 provides protection to various parts of the drive mechanism 30 to keep foreign objects, such as dirt, rocks, and the like, from fouling the operation of the drive mechanism 30. Such a flashing 59 may also provide a more aerodynamic leading surface to the drive mechanism 30. As may be appreciated, various types of such a structure can be incorporated into the drive mechanism 30.

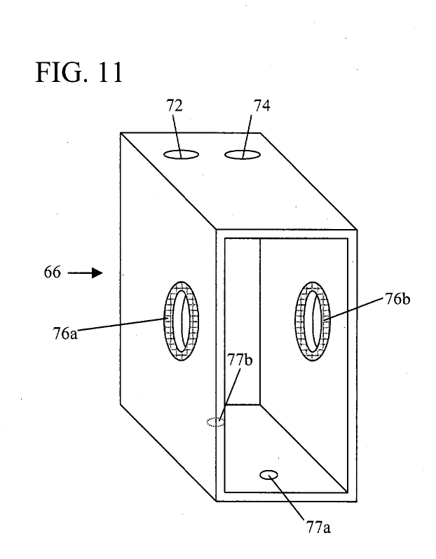

As illustrated in FIG. 11, the transmission bracket 66 includes a first chain hole 72, a second chain hole 74, drive shaft bearings 76a-b and a number of mounting holes 77a-b. The first chain hole 72 and the second chain hole 74 are formed in the top portion of the transmission bracket 66 to allow the second chain 64 to move freely through the transmission bracket 66. The drive shaft bearings 76a-b provide positions to mount the drive shaft 68 and the mounting holes 77a-b provide position to mount the transmission bracket to the bicycle frame 12.

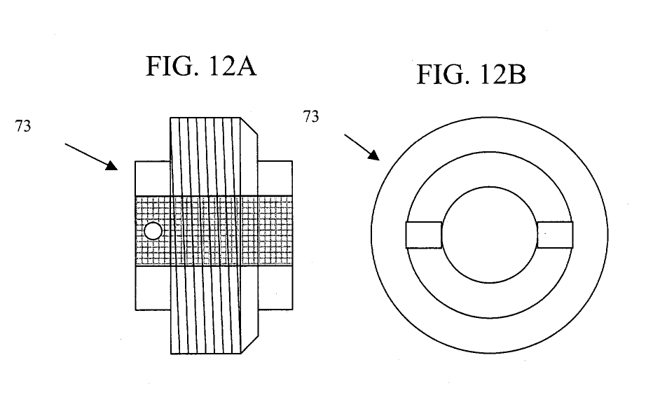

As illustrated in FIGS. 3, 4, 12A, 12B, 13A and 13B the first free-wheel 60 and the second free-wheel 62 are rotationally positioned in a side-by-side fashion on the drive shaft 68. The first and second free-wheels 60, 62 are connected to the drive shaft 68 by a first free-wheel collar 73 and a second free-wheel collar 75 along their interior circumference. Second free wheel collar 75 is similar in shape and size to first free wheel collar 73 as illustrate in FIGS. 12A-B. The drive shaft 68 runs through each of the free-wheel collars 73, 75 and is connected to the drive gear 78. In one embodiment, the free-wheel collars 73, 75 may be connected to the drive shaft 68 by a key way and key lock. In further embodiments the free-wheel collars 73, 75 may be attached to the drive shaft 68 by a set screw. In yet another embodiment, the free-wheels 60, 62 may be directly linked to the drive shaft 68 without the need for collars 73, 75.

The first free-wheel 60 and the second free-wheel 62 are positioned so that the free rotation of free-wheels 60, 62 and the driving direction of free-wheels 60, 62 are in the same direction. When one free-wheel 60 is driving in a first direction, the second free-wheel 62 spins freely in the opposite direction. In other words, when the first free-wheel 60 is operably engaging and driving the first free-wheel collar 73, the drive shaft 68, and thus the drive gear 78, the second free-wheel 62 spins freely in the opposite direction and applies relatively minimal counterproductive torque to the second free-wheel collar 75 and the drive shaft 68.

In the present embodiment, springs (not shown) may be positioned at an interior bottom end of both the first track 52 and the second track 54 such that the springs cushion the end of each stroke of the first pedal 32 and the second pedal 36. The springs cushion between each pedal guide 40, 42 and the end of its respective track 52, 54. The springs in such an embodiment are mounted on the end of tracks 52, 54 closest to the transmission bracket 66 such that the second chain 64 runs freely through the center of the spring. The energy lost in cushioning the pedal guides 40, 42 may be partially or wholly returned by the spring during the return stroke. The size and strength of these springs can vary depending on the embodiment and the user's preference. In other alternative embodiments, a rubber stopper with a hole through the center for passage of the chain can be positioned at the distal ends of the tracks 52, 54 to prevent metal on metal contact between the guides 40, 42 and the end of tracks 52, 54.

The linear pedal drive mechanism 30 allows the rider to utilize an optimal amount of energy provided by each of the rider's strokes. The drive mechanism 30 furthermore provides consistent power to the drive gear 78 and the drive chain 80 throughout each portion of the rider's leg strokes.

Operation of Mechanism

In operation, the present invention provides unidirectional torque to the drive shaft 68 from alternating linear motion. The present invention utilizes a “continuous” chain loop to achieve the application of force to the drive shaft 68 and the drive gear 78.

The operation of the drive mechanism 30 will now be described. The operation of the drive mechanism 30 is described using an up and down vertical orientation as illustrated in FIG. 1. As may be appreciated, in alternative embodiments the drive mechanism 30 may be placed in a variety of different orientations on various vehicles.

As may be understood by looking at FIGS. 3 and 4, the application of pressure to the first pedal 32 and pedal guide 40 results in torque being applied to the drive shaft by the second free-wheel 62. When the first pedal 32 is forced downward by the rider, the force is transferred through the first pedal arm 34, through the first pedal guide 40, and to the first chain 55. The first chain 55 transfers this force over the first idler sprocket 56 and exerts an upward force on the second pedal guide 42, causing the second pedal guide 42 to move upwards in the second track 54. The upward movement of the second pedal guide 42 pulls the second chain 64 up at the same time. As previously noted, the second chain 64 is connected from the second pedal guide 42 down to the second free-wheel 62. The movement of the second chain 64 causes the second free-wheel 62 to rotate in a clockwise motion.

Rotation in the clockwise direction is the driving direction of the present embodiment. The teeth of the second free-wheel 62 are engaged by the second chain 64. The second free-wheel 62 rotates in a clockwise direction and causes the first inner loop to rotate in a clockwise direction because they are fixedly connected. Because clockwise is the direction in which the first inner loop and the second inner loop “engage”, the second inner loop also is rotated in a clockwise direction. The free-wheel collar 75 is fixedly connected to both the drive shaft 68 and the second inner loop of the free-wheel 62. The second inner loop, the free-wheel collar 75, and the drive shaft 68 are all therefore spun in a clockwise direction. The drive gear 78 is then also turned in a clockwise motion to cause a drive chain 80 to power the rear wheel 28.

The total stroke length, or the distance from the top most point that each pedal 32, 36 reaches and the bottom most point that each pedal 32, 36 reaches, may be approximately 14 inches. This stroke length is approximately the same as a conventional rotary powered bicycle and therefore allows the rider to feel comfortable pedaling. Such a stroke length may be modified. Furthermore, an alternative embodiment drive mechanism 30 may include a way to adjust the stroke length to match the rider's preference.

The second chain 64 is connected to the first free-wheel 60 via the second idler sprocket 70. The downward movement of the first pedal guide 40 and the upward movement of the second pedal guide 42 cause the first free-wheel 60 to rotate in a counterclockwise direction. The first free-wheel 60 freely rotates past the drive shaft 68 and exerts minimal friction thereon because of the action of the free-wheel collar 73. The second chain 64 then runs vertically to connect with the first pedal guide 42. When the downward motion of the first pedal 32 stops and downward force is then exerted on the second pedal 36, the first and second free-wheels 60, 62 “lock” and “unlock” respectively. The first free-wheel 60 now exerts clockwise rotational force to the drive shaft 68 and the second free-wheel 62 spins freely in a counterclockwise direction. As may be appreciated, the action of the first chain 55, the second chain 64, and the other parts of the drive mechanism 30, run in the reverse manner as that described above. The length of the chain 64 is carefully adjusted so that no slack exists. If any slack were to exist, it could be eliminated by the adjustment of the second idler sprocket brackets 71a-b.

As previously stated, the drive gear 78 interacts with a drive chain 80 to power the bicycle. The drive gear 78, the drive chain 80, and the other portions of the propulsion system that is rearward of the drive mechanism 30 as illustrated in FIG. 1 may be substantially the same as in a conventional rotary powered bicycle. There may be more than one drive sprocket corresponding to different sets of gears, a derailleur, and a sprocket set at the back that allow the rider to transfer power to the rear drive wheel at a different ratio. Such a system, and modifications to such a system, are known to those in the art and are therefore not further described herein.

In one alternative embodiment, the transmission housing 66 may be mounted on the top of the drive mechanism 30. In such an operation, most of the portions of the mechanism 30 would operate in the opposite direction as described above. Such an alternative embodiment would require that the drive gear 78 and the drive chain 80 be positioned substantially at the top of the drive mechanism 30. A secondary flashing may be included to protect the workings of the drive gear 78 and the chain 80 from interference with the rider's clothes and such. Also included in such a design may be the ability of the drive mechanism 30 to pivot about the axis of the drive shaft 68. Such a slight pivot may change the vertical orientation of the drive mechanism 30. For example, when the bicycle was going up a steep hill, the drive mechanism 30 may pivot backwards. Pivoting in this way may reduce the friction between the pedal guides 40, 42 and their respective interior track 52, 54 when the drive mechanism is no longer operating in substantially vertical orientation.

In an alternative embodiment of the drive mechanism 30, the first chain 55 may connect the top of the first and second pedal guides 40, 42. The second chain 64 running from the bottom of the second pedal guide 42 and over the front side of the second free-wheel 62. The second idler sprocket 70 is mounted on the back side of the drive mechanism 30 to receive the second chain 64, which then extends to the front side of the first free-wheel 60. In this manner the application of pressure on the first pedal guide 40 causes the first pedal guide 40 to apply motive power to the drive shaft 68 and causes the second free-wheel 62 to freely rotate.

The embodiments described herein are for illustrative purposes and are not meant to exclude any derivations or alternative methods that are within the conceptual context of the invention. It is contemplated that various deviations can be made to these embodiments without deviating from the scope of the present invention. Accordingly, it is intended that the scope of the present invention be dictated by the appended claims rather than by the foregoing description of this embodiment.

What is claimed is:

1. A drive mechanism for converting a rectilinear driving force to a rotary drive force for propulsion of a vehicle, comprising:
an interior track assembly including a first and second parallel path, a first and second guide affixed in the track assembly in a manner wherein the first and second guide are movable along the first and second paths, respectively;
first and second pedals, the first and second pedals operably affixed to the first and second guide respectively;
a first chain connecting the first and second guide, the first chain running from the first guide, through operable interaction with a first idler sprocket, and then to the second guide;
a second sprocket operably attached to the interior track assembly;
a first free-wheel and a second free-wheel mounted to a drive shaft at a distal end of the interior track assembly wherein a second chain connects the first guide to the second guide through operable engagement with the first free-wheel, the second idler sprocket, and the second free-wheel.

2. The mechanism of claim 1 wherein the second idler sprocket is attached to a second idler sprocket bracket.

3. The mechanism of claim 1 further comprising a flashing.

4. The mechanism of claim 1 wherein the first and second free-wheel further comprise a first and second free-wheel collar operably attached to the interior circumference of the same.

5. The mechanism of claim 1 wherein the first and second guides further include a plurality of bearing and bearing rings for operably engaging the interior track assembly.

6. The mechanism of claim 1 further comprising a first spring and a second spring operably attached in the interior track assembly for cushioning the first guide and the second guide from contact with the bottom of the respective track and returning an amount of the stored energy into the drive mechanism on the next stroke.

7. The mechanism of claim 1 whereby the drive mechanism is operably connected to a bicycle.

8. The mechanism of claim 7 wherein the bicycle includes a first wheel and a second wheel, the drive mechanism applying driving force to the second wheel through a drive sprocket and a drive gear.

9. The mechanism of claim 1 whereby the drive mechanism is operably connected to a tricycle.

10. The mechanism of claim 1 whereby the drive mechanism is operably connected to a water trike.

11. The mechanism of claim 1 whereby the drive mechanism is operably connected to a propeller.

12. A pedaled propulsion apparatus for propelling a vehicle, comprising:
a track assembly with a first and second interior track operably mounted to the vehicle;
a first and second pedal guide movably situated in the first and second interior tracks, respectively, the first and second pedal guide each attached to a first and second pedal arm and a first and second pedal; and
a first chain and a second chain, the first chain attached to a first end of the first pedal guide, operably engaging a first idler sprocket rotationally affixed to the track assembly and thereafter affixed to the second pedal guide, the second chain sequentially engaging a second end of the first pedal guide, a first free-wheel, a second idler sprocket, a second free-wheel, and a second end of the second pedal guide, wherein the second idler sprocket is rotationally affixed to the track assembly and the first and second free-wheels are drivingly mounted to a drive shaft wherein when one free-wheel rotates the drive shaft in an operable direction to provide propulsion the other free-wheel rotates freely.

13. The apparatus of claim 12 wherein the drive shaft is mounted in a transmission bracket.

14. The apparatus of claim 12 further comprising a flashing.

15. The apparatus of claim 12 wherein the first and second free-wheels include a first and second collar mounted to the interior circumference of each free-wheel between the free-wheel and the drive shaft.

16. The apparatus of claim 12 where the first pedal guide, the first chain, the second pedal guide, and the second chain form a continuous loop.

17. The apparatus of claim 16 whereby the continuous loop is defined by the first idler sprocket, the first free-wheel, the second free-wheel, and the second idler sprocket.

18. The apparatus of claim 17 whereby slack in the continuous loop is removed by adjusting the second idler sprocket.

19. The apparatus of claim 12 whereby the deflection properties of the chain allow the chain to transverse between different planes of operation.

20. A drive mechanism for converting a rectilinear driving force to a rotary drive force for propulsion of a vehicle, comprising:
a housing including an interior track assembly, the interior track assembly including a first and second path;
a first and second pedal fixedly attached to a first and second pedal guide, respectively, the first and second pedal guide in movable engagement with the first and second path;
a first chain connecting the first and second guide through engagement with a first idler sprocket;
a first free-wheel and a second free-wheel fixedly connected at a position below the first and second path and operably attached to a drive shaft;
a second idler sprocket fixedly connected above the first and second free-wheels; and
a second chain connected to the first and second pedal guide through engagement with the first free-wheel, the second idler sprocket, and the second free-wheel.
